(19) United States
(12) Patent Application Publication
(10) Pub. No.: US 2022/0196498 A1
(43) Pub. Date: Jun. 23, 2022

(54) FORCE SENSOR SAMPLE CLASSIFICATION

(71) Applicant: Cirrus Logic International Semiconductor Ltd., Edinburgh (GB)

(72) Inventors: Eric LINDEMANN, Austin, TX (US); Josh SANZ-ROBINSON, Austin, TX (US); Pablo PESO PARADA, London (GB)

(73) Assignee: Cirrus Logic International Semiconductor Ltd., Edinburgh (GB)

(21) Appl. No.: 17/128,859

(22) Filed: Dec. 21, 2020

(51) Int. Cl. G01L 5/00; G01L 5/10

(52) U.S. Cl. CPC G01L 5/0038; G01L 5/10

(57) ABSTRACT

A classifier for classifying sensor samples in a sensor system, the sensor system comprising N force sensors each configured to output a sensor signal, where N>1, each sensor sample comprising N sample values from the N sensor signals, respectively, defining a sample vector in N-dimensional vector space, the classifier having access to a target definition corresponding to a target event, the target definition defining a bounded target region of X-dimensional vector space, where X≤N, the classifier configured, for a candidate sensor sample, to perform a classification operation comprising: determining a candidate location in the X-dimensional vector space defined by a candidate vector corresponding to the candidate sensor sample, the candidate vector being the sample vector for the candidate sensor sample or a vector derived therefrom; and generating a classification result for the candidate sensor sample based on the candidate location, the classification result labelling the candidate sensor sample as indicative of the target event if the candidate location is within the target region.

### FIELD OF DISCLOSURE

The present disclosure relates in general to sensor systems which comprise force sensors, and in particular to classification of sensor samples obtained from such force sensors.

A classifier may be provided for use in such a sensor system to classify sensor samples.

### BACKGROUND

Force sensors and sensor systems having force sensors may be provided for use with, or as part of, a host device. A host device having force sensors may be referred to as a sensor system or force sensor system.

In this context, a host device may be considered an electrical or electronic device and may be a mobile device. Example devices include a portable and/or battery powered host device such as a mobile telephone or smartphone, an audio player, a video player, a PDA, a mobile computing platform such as a laptop computer or tablet and/or a games device.

In general, a force sensor is configured to output a sensor signal indicative of a temporary mechanical distortion of a material under an applied force. The material may for example be a metal plate which is part of, or associated with, the force sensor, and which is pushed/pressed or otherwise deformed by a user. In the context of a host device, the material may be part of a chassis or external casing of the device. The force may for example be applied and subsequently reduced or removed in a user press operation, referred to as a button press where the force sensor is used to implement a button, the user press operation starting when the force is applied.

Force sensing may be carried out by a variety of different types of force sensor. Example types of force sensor include capacitive displacement sensors, inductive force sensors, strain gauges, piezoelectric force sensors, force sensing resistors, piezoresistive force sensors, thin film force sensors and quantum tunnelling composite-based force sensors. Force sensor systems may comprise a mixture of types of sensor/sensor technology.

Modern electronic devices are increasingly using “virtual button” technology to replace tradition push buttons. An example is the volume or power button on the side of a smartphone. The traditional buttons have contacts that can age and wear, and virtual buttons not only avoid this problem, but can be made without introducing openings in the smartphone chassis, thus increasing waterproofing and reducing general exposure to dirt and grease.

To replace physical buttons, virtual buttons are implemented using a number of force sensors in a force sensor system as described above. In the context of a smartphone, as a convenient running example of a host device, a number of such sensors may be arranged on the inside of the chassis—e.g. on the inside left-side and/or right-side edges or on the front or back of the device. The sensors are then responsive to physical pressure applied to the chassis.

Generally, the objective is to define a certain region of the device chassis as corresponding to a virtual button, and to use sensor information to determine when that region of the chassis has enough applied force to constitute an associated button press. Often multiple regions are defined corresponding respectively to multiple virtual buttons.

In general, N sensors may be arranged at various locations on the inside of the chassis, and it may be desirable to detect M virtual button presses corresponding to M regions on the outside of the chassis.

Using a naïve approach to this arrangement, the N sensors may be arranged so that there is one sensor situated directly in the middle of each virtual button region, with M=N.

Then, if the response of a given sensor exceeds a certain threshold, it may be determined that the associated virtual button has been pressed.

There are a number of problems with this naïve approach. When force is applied anywhere on the chassis, it is typical that all sensors will respond to some degree to that force. The naïve approach may be modified by insisting not only that the response of a sensor associated with a virtual button exceed a certain threshold, but that it also be the maximum response of all of the sensors.

This modified approach also has problems, however. For example, if there are two or more virtual buttons, such as buttons A to C, it may be desirable to detect the case where buttons A and B are pressed simultaneously. Furthermore, it might be desirable to differentiate that case from a case where the user has inadvertently applied force directly in between buttons A and B. Both of these cases might register the same response levels on sensors A and B positioned to implement buttons A and B, respectively, but in the first case the correct output is that both buttons have been pressed, whereas in the second case the correct output may be that neither button has been pressed.

In another example, the user might pinch, squeeze, or bend the device chassis. This action may result in responses from the various sensors, and, using the naïve approach, some of these responses may be interpreted, erroneously, as button presses. In general, it is desirable to avoid registering these “anomalies”—pressing between virtual buttons, or pinching, squeezing, or bending the chassis—as button presses.

A need exists, given N sensors and M virtual buttons, where N>1 and M>1, to use the information available from the N sensors to classify sensor responses as corresponding to valid virtual button presses and not anomalies.

It is desirable to address some or all of the above problems. It is desirable to provide an improved classifier for classifying sensor samples in a sensor system which comprises N force sensors, and associated methods and computer programs.

### SUMMARY

According to a first aspect of the present disclosure, there is provided a classifier for classifying sensor samples in a sensor system, the sensor system comprising N force sensors each configured to output a sensor signal, where N>1, each sensor sample comprising N sample values from the N sensor signals, respectively, defining a sample vector in N-dimensional vector space, the classifier having access to a target definition corresponding to a target event, the target definition defining a bounded target region of X-dimensional vector space, where X≤N, the classifier configured, for a candidate sensor sample, to perform a classification operation comprising: determining a candidate location in the X-dimensional vector space defined by a candidate vector corresponding to the candidate sensor sample, the candidate vector being the sample vector for the candidate sensor sample or a vector derived therefrom; and generating a classification result for the candidate sensor sample based on the candidate location, the classification result labelling the candidate sensor sample as indicative of the target event if the candidate location is within the target region.

The classifier may be configured in a tightening operation to adjust the target definition to reduce a size of the target region, and/or in a loosening operation to adjust the target definition to increase the size of the target region. The classifier may be configured to carry out the tightening operation and/or the loosening operation in response to a sensitivity control signal.

The target definition may define the bounded target region relative to a target location in the X-dimensional vector space, optionally being an optimum or preferred location corresponding to the target event concerned.

The target definition may define the bounded target region as locations in the X-dimensional vector space within a target distance of the target location. The classifier may be configured in the classification operation to label the candidate sensor sample with its classification result as indicative of the target event if the candidate location is within the target distance of the target location.

The classifier may be configured in the classification operation to apply a mathematical transformation to the sample vector to generate the candidate vector. The transformation may comprise at least one of: a discrete cosine transformation, DCT; a Karhunen-Loeve transformation, KLT; and/or Linear Discriminative Analysis, LDA. The transformation may comprise a matrix multiplication or a calculation effecting the matrix multiplication, optionally wherein the matrix multiplication comprises multiplication by a DCT, KLT and/or LDA matrix.

The transformation may comprise: a normalisation operation, optionally being a weighted normalisation operation; and/or a dimension-reduction operation configured to generate the candidate vector with reduced dimensions compared to the sample vector, where X<N.

The target region may comprise a target sub-region which is on a hypersurface defined in the X-dimensional vector space.

The classifier may be configured to: for each sensor sample, apply the normalisation operation in generating the candidate vector to normalise the magnitude of the candidate vector so that it defines a location on the hypersurface; and in the classification operation, label the candidate sensor sample with its classification result as indicative of the target event if: the candidate location is within the target sub-region; or the candidate location is within the target sub-region and a magnitude of the sample vector or candidate vector meets a defined target criterion.

The hypersurface may define a hypersphere or a hyperellipsoid. The hypersurface may define a unit-radius hypersphere and the normalisation operation may cause the candidate vector to be a unit-length vector.

The defined target criterion may comprise the magnitude of the sample vector or candidate vector exceeding a target threshold value.

The classifier may have access to a plurality of target definitions corresponding respectively to a plurality of target events, each target definition defining a corresponding bounded target region of the X-dimensional vector space, the classifier configured in the classification operation to: label the candidate sensor sample with its classification result as indicative of one or more of the plurality of target events based on whether the candidate location is within the corresponding target regions.

The classifier may be configured in the classification operation to, if the candidate location is within the target region of at least two target events, label the candidate sensor sample with its classification result as indicative of only one of the at least two target events, optionally based on a comparison of proximities of the candidate location to respective defined reference locations within the target regions of the at least two target events. The defined reference locations may be centroids of the target regions concerned and/or defined optimum or preferred locations corresponding to the target events concerned.

The classifier may be configured in the classification operation to label the candidate sensor sample with its classification result as indicative of an anomalous event if the candidate location is not within a defined target region.

The classifier may be configured to perform a series of classification operations for a series of candidate sensor samples to generate a corresponding series of classification results, respectively, and to determine that a given target event occurred based on the series of classification results.

The classifier may be configured to determine that the given target event occurred if: at least a threshold number of those classification results label their candidate sensor samples as indicative of the given target event; and/or at least the threshold number of those classification results which are consecutive in the series of classification results label their candidate sensor samples as indicative of the given target event.

The classifier may comprise a state machine configured to transition between defined states based on the series of classification results. At least one said state may indicate that a defined target event occurred. The classifier may be configured to determine that the defined target event occurred when the current state indicates that the defined target event occurred.

The classifier may be configured to store each target definition. The classifier may be configured to generate at least one target definition based on a corresponding training dataset of training sensor samples recorded for the target event concerned.

The classifier may be configured generate the at least one target definition by: determining a training location for each of the training sensor samples of the corresponding training dataset in the same way as a candidate location is determined for a candidate sensor sample; and generating the at least one target definition based on the training locations concerned.

The classifier may be configured to generate the at least one target definition by: calculating an average location based on an average of the training locations concerned; and/or determining a boundary for the bounded region concerned which encompasses some or all of the training locations concerned.

It may be that N≥3, or N≥4, or N≥8. The X-dimensional vector space and/or N-dimensional vector space may be feature space and/or Euclidean space. Each sensor signal may be indicative of an applied force. The force sensors of the sensor system may be arranged to detect an applied force corresponding to a press of at least one virtual button, each target event corresponding to a press of a virtual button.

According to a second aspect of the present disclosure, there is provided a trained ML classifier for classifying sensor samples in a sensor system, the sensor system comprising N force sensors each configured to output a sensor signal, where N≥1, each sensor sample comprising N sample values from the N sensor signals, respectively, the trained ML classifier trained to classify a candidate sensor sample as corresponding to one or none of a number of defined target events based on its sample values, the trained ML classifier configured to: receive a candidate sensor sample; and generate a classification result for the candidate sensor sample labelling the candidate sensor sample as indicative of one or none of the number of defined target events.

According to a third aspect of the present disclosure, there is provided a computer-implemented method of training an untrained classifier to generate a trained ML classifier for classifying sensor samples in a sensor system, the sensor system comprising N force sensors each configured to output a sensor signal, where N≥1, each sensor sample comprising N sample values from the N sensor signals, respectively, the method comprising: obtaining a first training dataset of labelled training sensor samples recorded for a number of defined target events, each of those training sensor samples labelled as corresponding to a respective one of the defined target events, wherein for each of the defined target events at least a plurality of those training sensor samples are labelled as corresponding to that target event; optionally obtaining a second training dataset of labelled training sensor samples recorded for a number of events other than the defined target events, each of those training sensor samples labelled as corresponding none of the defined target events; and training the untrained classifier with the first and/or second training datasets using supervised learning to generate the trained ML classifier.

According to a fourth aspect of the present disclosure, there is provided a classification system for classifying sensor samples in a sensor system, the sensor system comprising N force sensors each configured to output a sensor signal, where N≥1, each sensor sample comprising N sample values from the N sensor signals, respectively, the classification system comprising a classifier and a state machine, wherein: the classifier is configured, for each of a series of candidate sensor samples, to perform a classification operation based on the N sample values concerned and generate a classification result which labels the candidate sensor sample as indicative of a defined target event, thereby generating a series of classification results corresponding to the series of candidate sensor samples, respectively; and the state machine is configured to transition between defined states based on the series of classification results, and optionally to output a signal indicating a current state of the state machine.

At least one said state may indicate that a particular defined target event occurred. The state machine may be configured to output a signal indicating a current state of the state machine and/or indicating when the current state indicates that the particular defined target event occurred.

The state machine may be configured to transition between the defined states based on the series of classification results and additional information. The classifier may be configured to generate a confidence metric for each classification result, and the state machine may be configured to transition between the defined states based on the series of classification results and their confidence metrics.

Each confidence metric may indicate a degree of confidence in its classification result. The state machine may be configured to require, for transitioning from a first state to a second state, a greater degree of confidence in relation to the second state to transition to the second state than in relation to the first state to remain in the first state.

The state machine may be configured to implement hysteresis control in switching between states based on the series of classification results and/or their confidence metrics.

According to a fifth aspect of the present disclosure, there is provided a classification system for classifying sensor samples in a sensor system, the sensor system comprising N force sensors each configured to output a sensor signal, where N≥1, each sensor sample comprising N sample values from the N sensor signals, respectively, the classification system comprising a classifier and a determiner, wherein: the classifier is configured, for each of a series of candidate sensor samples, to perform a classification operation based on the N sample values concerned and generate a classification result which labels the candidate sensor sample as indicative of a defined target event, thereby generating a series of classification results corresponding to the series of candidate sensor samples, respectively; and the determiner is configured to output a series of event determinations corresponding to the series of classification results (or at least one event determinations based on the series of classification results), and to determine each event determination based on a plurality of the classification results.

The determiner may be configured to determine each event determination based on a corresponding plurality of consecutive classification results.

The determiner may be configured to output an event determination which indicates that a given target event has been determined to have occurred based on the series of classification results. The determiner may be configured to output an event determination which indicates that a given target event has been determined to have occurred if: at least a threshold number of those classification results label their candidate sensor samples as indicative of the given target event; and/or at least the threshold number of those classification results which are consecutive in the series of classification results label their candidate sensor samples as indicative of the given target event.

According to a sixth aspect of the present disclosure, there is provided a sensor system or a host device, comprising: the classifier or classification system as claimed in any of the preceding claims; and the N force sensors.

Also envisaged are corresponding method aspects, computer program aspects and storage medium aspects. Features of one aspect may be applied to another and vice versa.

### BRIEF DESCRIPTION OF THE DRAWINGS

Reference will now be made, by way of example only, to the accompanying drawings, of which:

FIG. 1 is a schematic diagram of a host device according to an embodiment;

FIG. 2 is a schematic diagram indicating how signals from force sensors of the host device may be arranged and handled;

FIG. 3 is useful for understanding the sensor samples may be taken to define sample vectors;

FIG. 4 is a schematic diagram of a classification system comprising a classifier according to an embodiment;

FIGS. 5 to 7 show plots of example signals useful for understanding applications of the classifiers;

FIG. 8 is a schematic diagram useful for understanding a target region or sub-region in the context of a hypersphere; and

FIG. 9 is a schematic diagram of a classifier according to an embodiment.

### DETAILED DESCRIPTION

The description below sets forth example embodiments according to this disclosure. Further example embodiments and implementations will be apparent to those having ordinary skill in the art. Further, those having ordinary skill in the art will recognize that various equivalent techniques may be applied in lieu of, or in conjunction with, the embodiments discussed below, and all such equivalents should be deemed as being encompassed by the present disclosure.

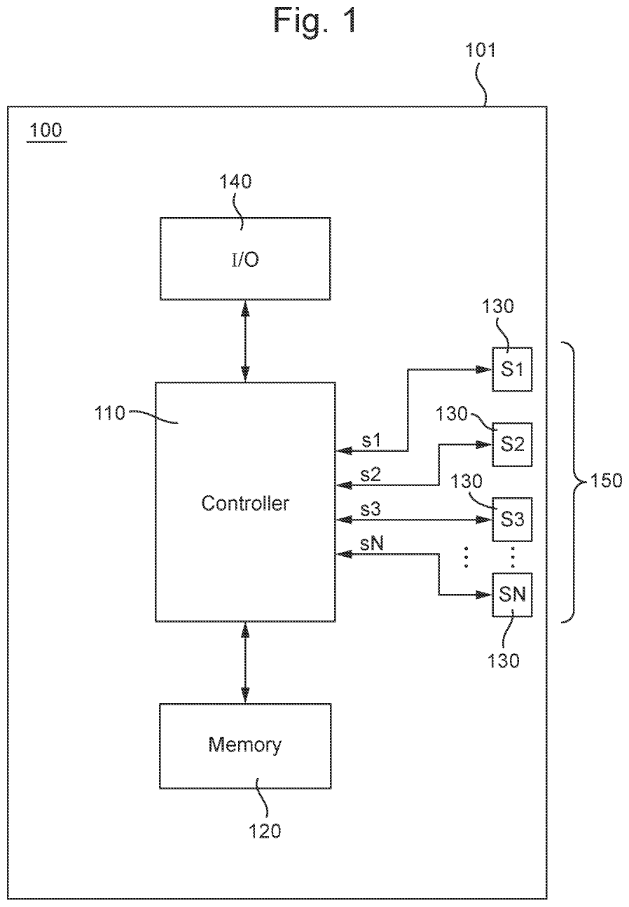

FIG. 1 is a schematic diagram of a host device 100 according to an embodiment, for example a mobile or portable electrical or electronic device. Example host devices 100 include a portable and/or battery powered host device such as a mobile telephone, a smartphone, an audio player, a video player, a PDA, a mobile computing platform such as a laptop computer or tablet and/or a games device.

As shown in FIG. 1, the host device 100 may comprise an enclosure 101, a controller 110, a memory 120, N force sensors 130, where N>1, and an input and/or output unit (I/O unit) 140. Although generally herein N>1 (i.e. two or more), for some arrangements considered herein N≥1 (i.e. one or more).

The enclosure 101 may comprise any suitable housing, casing, chassis or other enclosure for housing the various components of host device 100. Enclosure 101 may be constructed from plastic, metal, and/or any other suitable materials. In addition, enclosure 101 may be adapted (e.g., sized and shaped) such that host device 100 is readily transported by a user (i.e. a person).

Controller 110 may be housed within enclosure 101 and may include any system, device, or apparatus configured to control functionality of the host device 100, including any or all of the memory 120, the force sensors 130, and the I/O unit 140. Controller 110 may be implemented as digital or analogue circuitry, in hardware or in software running on a processor, or in any combination of these.

Thus controller 110 may include any system, device, or apparatus configured to interpret and/or execute program instructions or code and/or process data, and may include, without limitation a processor, microprocessor, microcontroller, digital signal processor (DSP), application specific integrated circuit (ASIC), FPGA (Field Programmable Gate Array) or any other digital or analogue circuitry configured to interpret and/or execute program instructions and/or process data. Thus the code may comprise program code or microcode or, for example, code for setting up or controlling an ASIC or FPGA. The code may also comprise code for dynamically configuring re-configurable apparatus such as re-programmable logic gate arrays. Similarly, the code may comprise code for a hardware description language such as Verilog™ or VHDL. As the skilled person will appreciate, the code may be distributed between a plurality of coupled components in communication with one another. Where appropriate, such aspects may also be implemented using code running on a field-(re)programmable analogue array or similar device in order to configure analogue hardware. Processor control code for execution by the controller 110, may be provided on a non-volatile carrier medium such as a disk, CD- or DVD-ROM, programmed memory such as read only memory (Firmware), or on a data carrier such as an optical or electrical signal carrier. The controller 110 may be referred to as control circuitry and may be provided as, or as part of, an integrated circuit such as an IC chip.

Memory 120 may be housed within enclosure 101, may be communicatively coupled to controller 110, and may include any system, device, or apparatus configured to retain program instructions and/or data for a period of time (e.g., computer-readable media). In some embodiments, controller 110 interprets and/or executes program instructions and/or processes data stored in memory 120 and/or other computer-readable media accessible to controller 110.

The force sensors 130 are housed within the enclosure 101, and are communicatively coupled to the controller 110. Each force sensor 130 may include any suitable system, device, or apparatus for sensing a force, a pressure, or a touch (e.g., an interaction with a human finger) and for generating an electrical or electronic signal in response to such force, pressure, or touch. Example force sensors 130 include or comprise capacitive displacement sensors, inductive force sensors, strain gauges, piezoelectric force sensors, force sensing resistors (resistive force sensors), piezoresistive force sensors, thin film force sensors and quantum tunnelling composite-based force sensors. There may be a mixture of types of force sensor amongst force sensors 130.

In some arrangements, the electrical or electronic signal generated by a force sensor 130 may be a function of a magnitude of the force, pressure, or touch applied to the force sensor (a user force input) via the enclosure 101. Such electronic or electrical signal may comprise a general purpose input/output signal (GPIO) associated with an input signal in response to which the controller 100 controls some functionality of the host device 100. The term “force” as used herein may refer not only to force, but to physical quantities indicative of force or analogous to force such as, but not limited to, pressure and touch.

The I/O unit 140 may be housed within enclosure 101, may be distributed across the host device 100 (i.e. it may represent a plurality of units) and may be communicatively coupled to the controller 110. Although not specifically shown in FIG. 1, the I/O unit 140 may comprise any or all of a microphone, an LRA (or other device capable of outputting a force, such as a vibration), a radio (or other electromagnetic) transmitter/receiver, a speaker, a display screen (optionally a touchscreen), an indicator (such as an LED), a sensor (e.g. accelerometer, temperature sensor, gyroscope, camera, tilt sensor, electronic compass, etc.) and one or more buttons or keys.

As a convenient example to keep in mind, the host device 100 may be a haptic-enabled device. As is well known, haptic technology recreates the sense of touch by applying forces, vibrations, or motions to a user. The host device 100 for example may be considered a haptic-enabled device (a device enabled with haptic technology) where its force sensors 130 (input transducers) measure forces exerted by the user on a user interface (such as a button or touchscreen on a mobile telephone or tablet computer), and an LRA or other output transducer of the I/O unit 140 applies forces directly or indirectly (e.g. via a touchscreen) to the user, e.g. to give haptic feedback. Some aspects of the present disclosure, for example the controller 110 and/or the force sensors 130, may be arranged as part of a haptic circuit, for instance a haptic circuit which may be provided in the host device 100. A circuit or circuitry embodying aspects of the present disclosure (such as the controller 110) may be implemented (at least in part) as an integrated circuit (IC), for example on an IC chip. One or more input or output transducers (such as the force sensors 130 or an LRA) may be connected to the integrated circuit in use.

Of course, this application to haptic technology is just one example application of the host device 100 comprising the plurality of force sensors 130. The force sensors 130 may simply serve as generic input transducers to provide input signals to control other aspects of the host device 100, such as a GUI (graphical user interface) displayed on a touchscreen of the I/O unit 140 or an operational state of the host device 100 (such as waking components from a low-power “sleep” state).

The host device 100 is shown comprising N force sensors 130, labelled S1 to SN, with their signals labelled s1 to sN, respectively. Although four sensors are shown explicitly, it will be understood that this is just a convenient example. It will be understood that the host device 100 generally need only comprise a pair of (i.e. at least two) force sensors 130 (i.e. N=2) in connection with the techniques described herein, although N=3 or N=4 may be considered advantageous in some arrangements. It may be said that N≥2 and that preferably N≥4. Generally, the larger the value of N the greater the possibility of distinguishing a button press for one virtual button from that for another, and the greater the number of virtual buttons that may be adequately defined. However, the larger the value of N the greater the number of sensor signals and thus the greater the complexity in handling them all.

Although FIG. 1 is schematic, it will be understood that the sensors S1 to SN are located so that they can receive force inputs from a user, in particular a user hand or finger, during use of the host device 100. A particular user force input of interest in this context corresponds to a user touching, pushing, or pressing a virtual button, or swiping the device corresponding to time-staggered virtual button presses. A change in the amount of force applied may be detected, rather than an absolute amount of force detected, for example.

Thus, the force sensors S1 to SN may be located on the host device 100 according to anthropometric measurements of a human hand (e.g. so that a single human hand will likely apply a force to multiple force sensors). For example, the force sensors S1 to SN may be provided on the same side of the host device 100. Merely as a running example, it will be understood that the force sensors S1 to SN are provided in a linear array 150 as indicated in FIG. 1. It will be understood that the force sensors 130 are provided at different locations on the device, but may be in close proximity to one another.

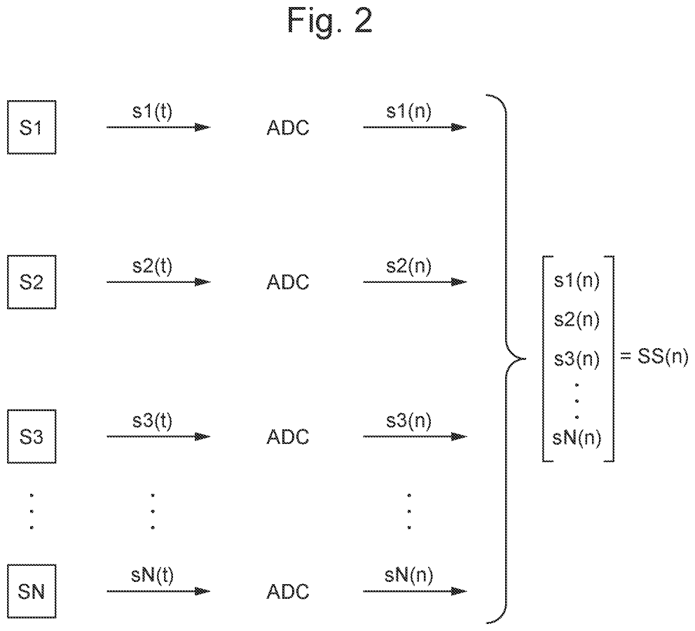

FIG. 2 is a schematic diagram indicating how the signals from the force sensors S1 to SN may be arranged and handled.

Depending on how the force sensors 130 are configured, the force sensors S1 to SN may provide analogue signals s1(t) to sN(t), respectively, where t is time e.g. in seconds. These analogue signals may then be converted by analogue-to-digital conversion, ADC, to corresponding digital sample streams s1(n) to sN(n), where n is the sample number. Of course, the force sensors S1 to SN may output respective digital sample streams s1(n) to sN(n) directly. Equally, classification may be performed based on the analogue signals in some arrangements, however classification based on the digital sample streams will be carried forwards as an example.

At this juncture, it is noted that force sensors 130 as deployed in modern host devices produce signals that have a slowly varying baseline level that is modulated by physical events (e.g. changes in ambient temperature or pressure). A baseline level may be taken to mean a level (e.g. bias level) at which a corresponding raw sensor signal is taken to indicate a zero magnitude or zero input. In the case of a force sensor, a baseline level may be taken to mean a level at which a corresponding raw sensor signal is taken to indicate zero applied force. A baseline signal may be taken to mean a signal which indicates baseline level. Ultimately, force information may be determined from a given raw sensor signal based on a difference between that raw sensor signal and its corresponding baseline signal.

Typically, the signals subject to analogue-to-digital conversion, ADC, are the raw sensor signals, i.e. before the baseline signals are subtracted therefrom. However, baseline subtraction could equally be applied prior to analogue-to-digital conversion. For simplicity, the baseline subtraction is not shown in FIG. 2.

It will be assumed, again for simplicity, that the sensor signals considered hereinafter (whether they are pre or post analogue-to-digital conversion) are sensor signals whose values are relative to their baseline levels, i.e. which indicate a difference between a raw sensor signal and its corresponding baseline signal.

Assuming the sample streams are synchronised for convenience, the force sensors S1 to SN may be considered to provide a stream of sensor samples SS(n), as indicated in FIG. 2, which each include a sample value from each of the N sensors. Each such sensor sample SS(n) may thus be represented in vector (or matrix) form as:

$$SS ( n ) = [ \begin{matrix}s 1 ( n ) \\ s 2 ( n ) \\ s 3 ( n ) \\ ⋮ \\ sN ( n )\end{matrix} ]$$

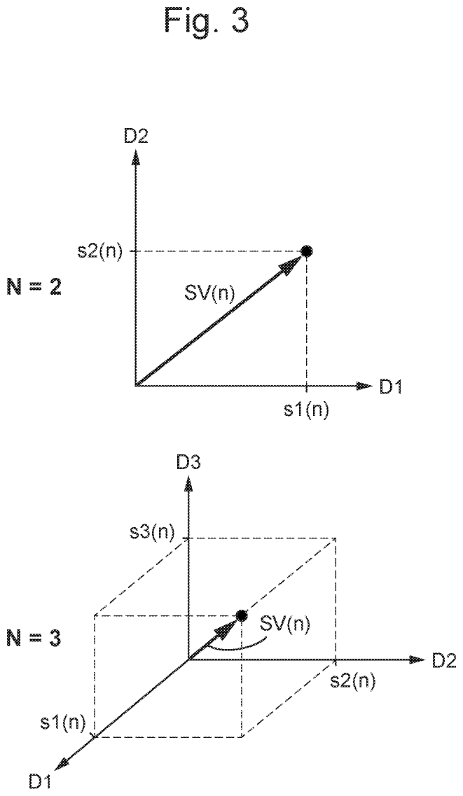

Taking N=2 and N=3 as examples, it can be understood that each sensor sample may be considered to define a sample vector SV(n) in N-dimensional vector space, where the dimensions are D1 to DN, as indicated in FIG. 3. Each sample vector SV(n) may then be taken to define a location in the vector space, as also indicated. Of course, although only up to three dimensions are shown in FIG. 3, it will be appreciated that for N≥4 higher dimensions of vector space may be considered.

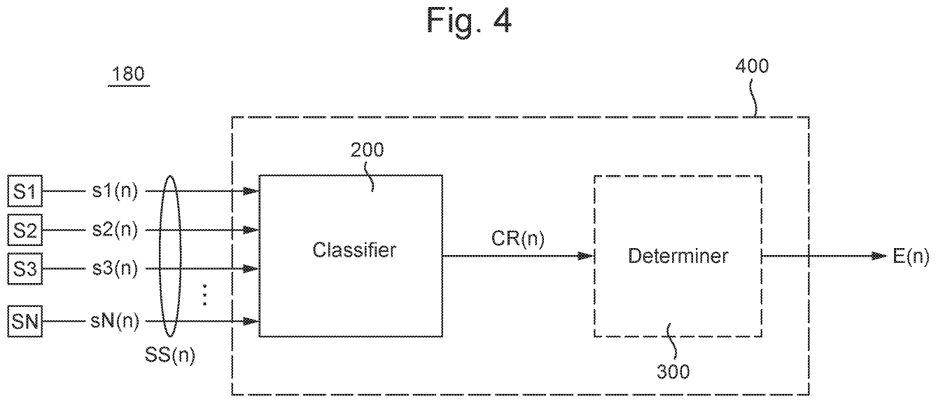

With the above in mind, FIG. 4 is a schematic diagram of a classification system 180, which may also be referred to as a classifier. The classification system 180 comprises a classifier 200 and a determiner 300, which together may be referred to as a classifier 400. Each of these classifiers may be considered an embodiment.

The classifier 200 is shown as receiving digital sample streams s1(n) to sN(n), from corresponding force sensors S1 to SN. In the general case, N>1 as above. The classifier 200 may be implemented in the host device 100, for example as, or as part of, the controller 110, and is shown as outputting a stream of classification results CR(n). In one arrangement the classifier 200 may be implemented as program code running on the controller 110.

The classifier 400 similarly may be implemented in the host device 100, for example as, or as part of, the controller 110. In one arrangement the classifier 400 may be implemented as program code running on the controller 110.

The classifier 200 is for classifying sensor samples SS(n) in a sensor system, the sensor system comprising N force sensors S1 to SN each configured to output a sensor signal, where N>1. The host device 100 having the force sensors 130 is an example such sensor system. Each sensor sample SS(n) comprises N sample values s1(n) to sN(n) from the N sensor signals, respectively, defining a sample vector SV(n) in N-dimensional vector space.

It is assumed that the classifier 200 has access to a target definition corresponding to a target event, the target definition defining a bounded target region of X-dimensional vector space, where N≥1 (to allow for dimension reduction, as mentioned later herein). Here, the target event may correspond to a button press of a virtual button defined relative to the force sensors S1 to SN. A bounded region may be a region which has a defined boundary, i.e. a continuous boundary. A bounded region may be enclosed on all sides, in the vector space.

With this in mind, and in overview, the classifier 200 is configured to classify a stream of sensor samples SS(n) one by one, and to output a corresponding stream of classification results CR(n).

Taking a candidate sensor sample SS(n) as an example, the classifier 200 is configured, for the candidate sensor sample, to perform a classification operation comprising determining a candidate location in the X-dimensional vector space defined by a candidate vector corresponding to the candidate sensor sample, the candidate vector CV(n) being the sample vector SV(n) for the candidate sensor sample or a vector derived therefrom. The classification operation further comprises generating a classification result CR(n) for the candidate sensor sample SS(n) based on the candidate location. The classification result would then label the candidate sensor sample SS(n) as indicative of the target event if the candidate location is within the target region.

In this way, taking each sensor sample SS(n) of a stream of sensor samples SS(n) in turn as a candidate sensor sample, a stream of classification results CR(n) corresponding to the stream of sensor samples SS(n) may be generated.

Looking at FIG. 3 for example, the target region could be understood to be a two-dimensional region where X=2 (recall that X≤1) and a three-dimensional region where X=3. Of course, the classifier may have access to a plurality of target definitions corresponding to a plurality of target events, respectively, the target definitions each defining a corresponding bounded target region of the vector space. Here, the target events may correspond to button presses of corresponding virtual buttons defined relative to the force sensors S1 to SN.

Also shown in FIG. 4 is the determiner 300, as mentioned earlier. The determiner 300 is configured to receive the stream of classification results CR(n), corresponding to the stream of sensor samples SS(n), and to output a corresponding stream of event determinations E(n). The determiner 300 will be considered in more detail later.

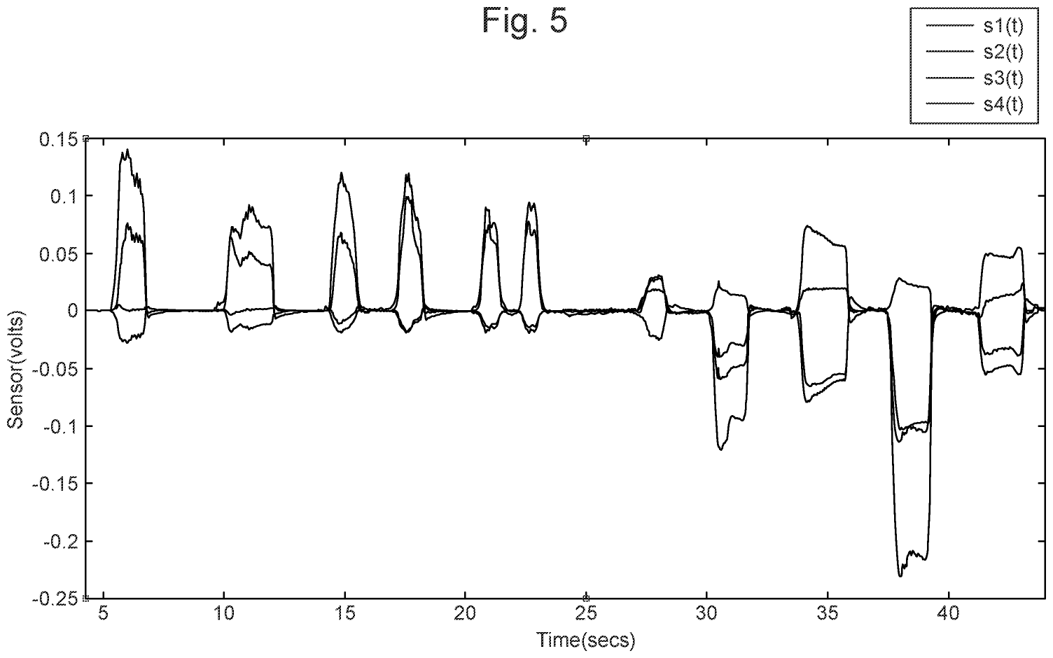

As a concrete example, FIG. 5 shows a plot of sensor signals s1(t) to s4(t) from a 4-sensor host device 100, i.e. where the sensors 130 comprise sensors S1, S2, S3 and S4. It will be appreciated that corresponding sensor streams s1(n) to s4(n) could be plotted with the X-axis indicating samples or time in seconds, with the plots looking the same, and the other plots considered herein will be understood accordingly.

It is assumed that the aim, in this example case, is to use the four sensors S1 to S4 to determine which of three virtual buttons VB1 to VB3 is pressed. The sensors in this case are arranged in the linear array 150 along the edge of the device 100, and the three virtual buttons in this example are defined as also on the edge of the device, arranged such that the VB1 region is between S1 and S2, the VB2 region is between S2 and S3, and the VB3 region is between S3 and S4.

When no force is applied to the device 100, the sensor signals rest near their baseline 0 values—e.g. from 7 to 9 seconds. The excursions from 5 to 7 and 10 to 12 seconds correspond to two presses of virtual button VB1 from 14 to 16 and from 17 to 18 to two presses of virtual button VB2, and from 21 to 22 and 23 to 24 seconds to two presses of virtual button VB3. All of the remaining excursions, from 27 to 43 seconds, correspond to various pinches, squeezes, and twists of the device enclosure or body 101—i.e. to anomalies (taken here to mean user inputs other than presses of defined virtual buttons).

As mentioned above, in each classification operation, for a given candidate sensor sample, the classifier 200 determines a candidate location in the vector space defined by a candidate vector corresponding to the candidate sensor sample, the candidate vector CV(n) being the sample vector SV(n) for the candidate sensor sample or a vector derived therefrom. It may be that the candidate vector CV(n) is derived from the sample vector SV(n) by virtue of a mathematical transformation.

As one example, continuing with N=4, the sensor samples SS(n) may be viewed as a four-length column vector defining the corresponding sample vector SV(n), i.e. as the vector:

$$S S ( n ) = S V ( n ) = [ \begin{matrix}s 1 ( n ) \\ s 2 ( n ) \\ s 3 ( n ) \\ s 4 ( n )\end{matrix} ]$$

This four-length vector SV(n) could be transformed into the corresponding candidate vector CV(n), also being a four-length vector, by multiplying it by a 4×4 transformation matrix.

For, example the transformation matrix could be a 4×4 DCT (Discrete Cosine

Transformation) matrix such as:

$$[ \begin{matrix}0.5000 & 0.5000 & 0.5000 & 0.5000 \\ 0.6533 & 0.2706 & - 0.2706 & - 0.6533 \\ 0.5000 & - 0.5000 & - 0.5000 & 0.5000 \\ 0.2706 & - 0.6533 & 0.6533 & - 0.2706\end{matrix} ]$$

Thus, the matrix multiplication could be:

DCT matrix·SV(n)=CV(n)

or using the above example DCT matrix:

$$[ \begin{matrix}0.5000 & 0.5000 & 0.5000 & 0.5000 \\ 0.6533 & 0.2706 & - 0.2706 & - 0.6533 \\ 0.5000 & - 0.5000 & - 0.5000 & 0.5000 \\ 0.2706 & - 0.6533 & 0.6533 & - 0.2706\end{matrix} ] \cdot [ \begin{matrix}s 1 ( n ) \\ s 2 ( n ) \\ s 3 ( n ) \\ s 4 ( n )\end{matrix} ] = C V ( n )$$

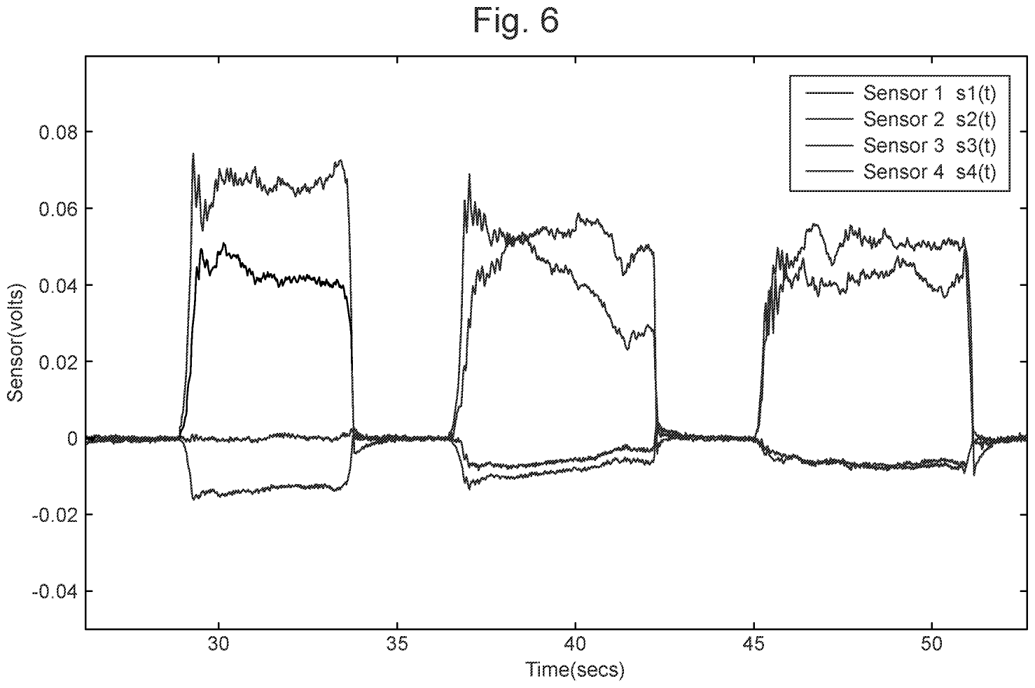

FIG. 6 shows another plot of sensor signals s1(t) to s4(t) from a 4-sensor host device 100, i.e. where the sensors 130 comprise sensors S1, S2, S3 and S4. It will again be appreciated that corresponding sensor streams s1(n) to s4(n) could be plotted as mentioned earlier.

Here the plots show the sensor values for three virtual button presses: virtual button VB1 from 29 to 34 seconds, virtual button VB2 from 37 to 42 seconds, and virtual button VB3 from 45 to 51 seconds.

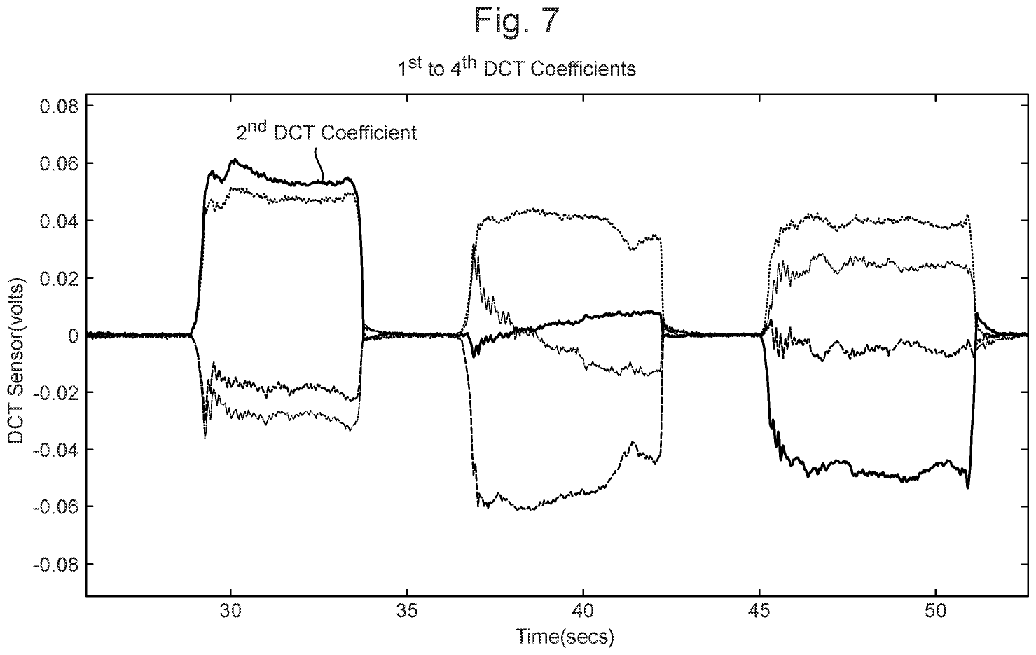

FIG. 7 shows the same three button presses but with the stream of four-length sensor vectors SV(n) transformed by the DCT matrix shown above to generate a corresponding stream of candidate vectors CV(n), with the four traces corresponding then to the four row entries of the single column of the candidate vectors CV(n).

The solid line in FIG. 7 corresponds to the 2nd DCT coefficient—i.e. the dot product between the 2nd row of the DCT matrix and the four-length sensor vector SV(n). The 2nd row of the DCT matrix is anti-symmetric and goes from positive to negative. If the sensors S1 to S4 in this example are arranged in the linear array 150 along a side of the host device 100 (e.g. along a metal strip corresponding to the edge of a smartphone), then the 2nd DCT coefficient represents the tilt that occurs in this side of the device when force is applied at some particular location. The virtual button VB1 press in FIG. 7 has a high positive tilt—i.e. high positive 2nd DCT coefficient. The virtual button VB2 press has a very small overall tilt, and the virtual button VB3 press has a high negative tilt.

The tilt corresponding to the 2nd DCT coefficient is approximately equal to a bending mode of the side of the host device 100 (e.g. a metal strip). The four sensor values s1(n) to s4(n), when transformed by the DCT matrix, provide four different bending modes of the side of the host device 100. The 1st DCT coefficient (based on the 1st row of the DCT matrix) is the bending mode that corresponds to the overall displacement of the side of the host device 100. The 2nd DCT coefficient (based on the 2nd row of the DCT matrix) corresponds to the overall tilt as mentioned above. The 3rd DCT coefficient (based on the 3rd row of the DCT matrix) corresponds to a U-shaped bending mode—i.e. negative displacement in the middle and positive displacement near the edges of the side of the host device 100. The 4th DCT coefficient (based on the 4th row of the DCT matrix) corresponds to an oscillatory bending mode: positive then negative then positive then negative along the side. The overall bending shape of the metal is described by the weighted sum —weighted by the DCT coefficients at each sample—of the 4 bending modes.

In the context of the DCT transformation, the four linearly spaced sensors S1 to S4 correspond to four spatial samples of the bending side (e.g. metal) of the device 100 at each time sample. The DCT then corresponds to a spatial frequency domain representation of the bending side with the higher DCT coefficients corresponding to higher spatial frequencies. The more sensors there are, and the more densely they are spaced, the higher the spatial frequencies provided by the DCT. This corresponds to more spatial resolution in determining the shape of the bending side. The DCT transformation is appealing because it is possible to more intuitively distinguish different button presses using spatial frequencies—e.g. tilt, U-shaped, etc.—than by looking at the raw sample values of individual sensors.

In a particular arrangement, where N=2, the DCT may be applied to a two-sensor configuration, i.e. a linear array 150 of sensors S1 and S2.

In this case the DCT matrix may be:

$$[ \begin{matrix}0.1000 & 0.1000 \\ 0.1000 & - 0.1000\end{matrix} ] * 0. 7071$$

In other words, the 2-dimensional DCT transform is just a weighting of the sum and difference of the sensor values. The scaling by 0.7071 (or 1/sqrt 2 ) shown here may be employed but is not essential to the DCT definition. Any scaling (including scaling by 1) is possible.

As another example, the transformation matrix could be a 4×4 KLT (Karhunen-Loeve Transformation) matrix. The DCT represents ideal bending modes for an ideal side of the host device 100, e.g. an ideal piece of metal. The KLT can be determined by sampling a wide variety of button presses and anomalies and then forming the 4×4 covariance matrix of the sampled four-length sensor vectors. The KLT matrix then corresponds to the eigenvectors of this 4×4 covariance matrix.

An example 4×4 eigenvector matrix corresponding to the button presses and anomalies of a particular smartphone device (as an example host device 100) is as follows:

$$[ \begin{matrix}0.3253 & - 0.5240 & - 0.7617 & 0.1989 \\ - 0.5 \; 173 & - 0.6695 & 0.3456 & 0.4060 \\ 0.7286 & - 0.0178 & 0.4566 & 0.5102 \\ 0.3095 & - 0.5263 & 0.3032 & - 0.7317\end{matrix} ]$$

The 2nd row of the above example KLT matrix still corresponds to an extent to tilt—i.e. it progresses negative to positive—but it is not ideally anti-symmetric. The KLT matrix has the property that it concentrates a description of the bending material (e.g. metal) for a particular device, in the fewest number of KLT coefficients. So, for a large number of sensors, it may be possible to ignore many of the higher KLT coefficients—i.e. dot products of the higher numbered rows of the KLT matrix with the sensor vectors—and use only a few of the lower coefficients, also called “principal components”, so that there is an X-length vector (where X<N), and still have an accurate description of the bending metal.

In another variation, Linear Discriminative Analysis (LDA) may be used to produce a transformation matrix in a similar manner to the DCT and KLT matrices discussed earlier. DCT, KLT, and LDA are based on linear transform matrices. However, the matrix used in LDA is specifically designed to maximize the difference between classes in a multiclass classification problem, and thus may be beneficial in some arrangements.

Combinations of such matrices, and matrix multiplications, may be used.

In another example, the mathematical transformation used to derive the candidate vector CV(n) from the sample vector SV(n) may comprise a normalisation operation, which may be a weighted operation (e.g. as regards particular dimensions).

This form of transformation may be carried out instead of or in addition to the types of transformation described above. That is, the N-length candidate vectors CV(n), or the DCT or KLT transformations, or principal components of the candidate vectors CV(n) (so that there is an X-length vector, where X<N), may be normalized so that the magnitude—i.e. square root of the sum of squares of the sample (sensor) values at each time step—is equal to e.g. one.

The justification for this is the observation that a particular virtual button—e.g. virtual button VB1—can be pressed with different levels of force. If the sensor response to force is reasonably linear, then to classify a sensor vector as corresponding to virtual button VB1 focus may be placed on the relative values of the sample values in a vector, rather than their absolute values.

Generally, however, it is desirable to require a minimum force to be applied before a button press is identified. Since the overall level of force is removed from the candidate vectors CV(n) when they are normalized, the force level can be calculated separately, e.g. as the magnitude of the candidate vectors CV(n) or corresponding sample vectors SV(n). The classifier 200 may then be configured to identify a potential virtual button press as one of a set of possible virtual button presses, and then, combine this detection with a determination of the magnitude of the press being above a threshold level, to label the candidate sensor sample SS(n) concerned as indicative of the virtual button press concerned.

In the example case of the 2-sensor DCT configuration mentioned above, the magnitude of the press is simply the 1st DCT coefficient, and the classification of which button is pressed is based (e.g. only) on the 2nd DCT coefficient, i.e. the difference between the two sensors.

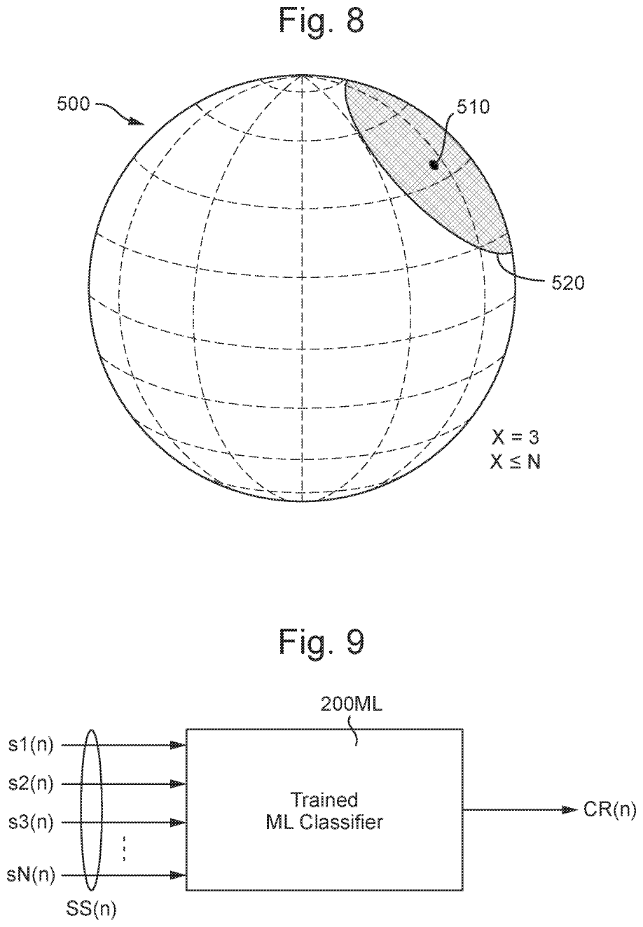

With reference to FIG. 3, the candidate vectors described herein can be viewed as defining a location (or point) in X-dimensional space. When the vectors (which may have been generated using DCT, KLT, and/or LDA transformation, and/or principal component selection) are normalised, they may be taken to define a location on a hypersurf ace in the X-dimensional space.

Where the normalisation is non-weighted, for example with the vectors after normalisation having a magnitude of 1 (an example unit value), the set of X-dimensional unit normalized vectors is the set of all vectors with magnitude 1. With reference to FIG. 8, which represents an example where X=3, these points all reside on a hypersphere 500 with radius 1 in X-dimensional space.

If a number of X-length candidate vectors, corresponding to a number of e.g. virtual button VB1 presses, are recorded and the normalized mean value of these vectors taken, a new normalized X-length vector representing the average virtual button VB1 press is obtained. This ‘average’ vector may be taken to define a location in the X-dimensional space and on the hypersphere which may be referred to as a virtual button VB1 ‘centroid’. An example virtual button VB1 centroid 510 is indicated in FIG. 8. Centroids for other virtual buttons, e.g. virtual buttons VB2, VB3, etc. could be obtained in a similar way. All of these centroids represent points on the X-dimensional unit radius hypersphere. Because the centroids are the average of a number of physical button presses, they also represent the ideal physical centre of the button on the device.

Thus, unit hypersphere centroids may be defined for all desired virtual buttons—VB1, VB2, VB3, etc., based on recorded virtual button presses or by design. When an input sensor vector is received, optionally transformed and perhaps reduced in dimension (so that X<N) by taking principle components, and normalized, the distance of the location on the hypersphere defined by its corresponding candidate vector from each centroid point may be found. Since each centroid represents the physical centre of a particular virtual button on the device 100, the calculated distance of a candidate location defined by a candidate vector CV(n) from the centroid on the hypersphere is also a measure of the physical distance from the ideal physical button centre associated with any input sample vector SV(n). If the distance from a centroid point is less than a centroid threshold, then the candidate sensor sample SS(n) concerned may be labelled as indicative of the virtual button press corresponding to that centroid. This corresponds to determining that the candidate location is within a target sub-region 520 (a region on the hypersphere within a larger region applicable if normalisation is not performed), as indicated in FIG. 8.

Of course, target sub-regions corresponding to target sub-region 520 may be defined based on centroids as above, or may be defined by boundaries which encompass e.g. a number of ‘approved’ recorded samples for a given virtual button press.

It is possible that a given candidate vector CV(n) defines a candidate location less than the centroid threshold distance away from more than one centroid. A candidate location might be in multiple regions/sub-regions (the regions could overlap), for example. In that case, one possibility is to label the candidate sensor sample SS(n) as indicative of a press of the virtual button corresponding to the centroid that the candidate location is nearest to.

If the distance of the candidate location from the centroids is greater than the centroid threshold for all centroids, i.e. it is not in any of the target sub-regions, then the candidate sensor sample SS(n) concerned may be classified as corresponding to an anomaly.

This approach has the advantage that it is not necessary to record or otherwise characterize anomalies. Instead, the target sub-regions may be defined for the virtual button presses of interest (through use of centroids and centroid thresholds or otherwise). For example, a virtual button centroid threshold may be used to define a relatively small region around a corresponding centroid, corresponding to a particular virtual button press. Any input candidate location not within one of these target sub-regions (button regions) is then automatically considered to correspond to an anomaly. This is advantageous because it may be difficult to characterize every imaginable squeeze, pinch, bend or other force induced anomaly for a given host device 100.

Adjusting the size of the target regions or sub-regions, for example by adjusting the centroid thresholds (in a tightening or loosening operation, e.g. in response to a sensitivity control signal), enables a trade-off of the physical width of a button region against immunity to anomalies. A tightening operation may involve decreasing the size of the target regions or sub-regions. A loosening operation may involve increasing the size of the target regions or sub-regions. This approach to classification (i.e. using bounded target regions) is in contrast to e.g. a linear SVM, which divides the N dimensional space using hyperplanes. Any input point is in some region according to this hyperplane division, and if anomalies are to be avoided, the anomalies must appear in training data so that hyperplanes can be drawn around them.

A button region that corresponds to a set of points less than a centroid threshold distance from a centroid point defines an ellipse-type region on the surface of the hypersphere. This is similar to a Gaussian Mixture Model (GMM), where button probabilities are defined for each point on the hypersphere. These probabilities correspond to N-dimensional Gaussian distribution “mountains” with one such Gaussian distribution per virtual button and the mean of each Gaussian distribution at a button centroid. The ellipse-type region for each button is then a region of constant probability associated with the Gaussian distribution for that button. Adjusting the centroid threshold is then equivalent to adjusting the minimum probability for an input vector to be classified as belong to a particular button class.

The ellipse-type region as defined above, i.e. the set of points less than the centroid threshold distance from the centroid point, effectively defines a circle on the surface of the hypersphere. However, the different points in (or dimensions of) the vector may be weighted differently, thus distorting the circle so that it becomes a more general ellipse-type region. This may be particularly useful in the context of transformed vectors where it may be desirable for e.g. tilt to be weighted more heavily than some other bending modes. Indeed, the normalisation may be weighted differently for different dimensions, so that the hypersurface may be a hyperellipsoid (not necessarily a ‘regular’ hypersphere).

A convenient measure of distance between any two points on a hypersphere is the angle between those points. This is conveniently computed because the cosine of the angle of any two unit-normalized vectors on an X-dimensional unit radius hypersphere is simply the dot product between those two vectors. This distance measure is referred to as “cosine similarity”. In one instance, cosine similarity is used to compute distance, and hence to classify, input vectors. But other measures of distance such as Euclidean distance can also be used.

One advantage of the cosine distance measure is that it is bounded between −1 and 1, 1 being the shortest possible distance and −1 being the largest. This eases the problem of scaling the distance compared to other distance measures. A disadvantage of the cosine measure is that it is non-linear with respect to physical distance from a button centroid. Taking the arccos of the consine distance produces the true angle with response to the hypersphere. This measure is linear with respect to physical distance from a button centroid.

Looking back at FIG. 4, the overall functionality (in the sense of inputs to outputs) of the classifier 200 may be performed using machine learning (ML). With this in mind, FIG. 9 is a schematic diagram of a trained ML classifier 200ML which may be employed in place of the classifier 200.

The trained ML classifier 200ML is configured to classify sensor samples SS(n) in a sensor system corresponding to that in which classifier 200 may be implemented, i.e. a sensor system comprising N force sensors each configured to output a sensor signal, where N>1, each sensor sample SS(n) comprising N sample values from the N sensor signals.

The trained ML classifier 200ML is trained to classify a candidate sensor sample SS(n) as corresponding to one or none of a number of defined target events based on its sample values, the trained ML classifier configured to receive a candidate sensor sample SS(n), and generate a classification result CR(n) for the candidate sensor sample labelling the candidate sensor sample SS(n) as indicative of one or none of the number of defined target events.

The trained ML classifier 200ML may be generated by training a classifier (such as a neural network) using a computer-implemented method. Such a method may involve obtaining first and optionally also second training datasets of labelled training sensor samples.

The first training data set of labelled training sensor samples may be recorded (e.g. synthesised) for a number of defined target events, each of those training sensor samples labelled as corresponding to a respective one of the defined target events, wherein for each of the defined target events at least a plurality of those training sensor samples are labelled as corresponding to that target event. The second training dataset of labelled training sensor samples, provided for contrast, may be recorded (e.g. synthesised) for a number of events other than the defined target events, each of those training sensor samples labelled as corresponding none of the defined target events.

The classifier may then be trained with the first and second training datasets (or e.g. just the first training dataset) using supervised learning. That is, each labelled training sensor sample constitutes an input-output pair, the input being the N sample values of that training sensor sample, and the output being the associated label (which corresponds to the intended or ‘correct’ classification result CR(n) for that training sensor sample). The supervised learning then learns a function that maps an input to an output based on the example input-output pairs from the first and/or second training datasets.

Thus, the trained ML classifier 200ML, rather than specifically considering sample vectors SV(n) and candidate vectors CV(n) and locations in N-dimensional or X-dimensional vector space as in the classifier 200, is implemented as a machine learning (ML) classifier. As above, the trained ML classifier 200ML could be trained using recordings (i.e. a training dataset) of different virtual button presses. For example, the ML classifier could be trained using a VB1 recording (training dataset) containing multiple instances of virtual button VB1 presses of various durations and force levels, a VB2 recording (training dataset) containing instances of virtual button VB2 presses and a VB3 recording (training dataset) containing instances of virtual button VB3 presses. A fourth recording (training dataset) may also be used containing instances of anomalies (user inputs other than presses of defined virtual buttons, such as pinching, twisting or squeezing the device 100).

Because each recording contains instances of a specific class of event—i.e. a virtual button VB1 press or a virtual button VB2 press, etc.—the events in these recordings are easily labelled. The labelled recordings are then used to train the ML classifier to identify different event classes.

Typical classifiers that can be trained in this way, include a neural network classifier, a linear support vector machine (SVM) classifier, a quadratic, cubic, or higher order SVM classifier, a Gaussian SVM classifier, a linear discriminant classifier, a decision tree classier, a bagged decision tree classifier, a boosted decision tree classifier. Many types of classifiers are known to those skilled in the art of machine learning classification. The above functionality does not depend on a particular choice of type of ML classifier.

The trained ML classifier 200ML may be trained with, and then supplied with during use, sensor samples SS(n), each sensor sample SS(n) comprising N sample values from the N sensor signals, or transformed versions of such sensor samples SS(n) corresponding to the candidate vectors CV(n) described above.

For example, the input-output pairs used for training may correspond to labelled candidate vectors CV(n) which were generated from corresponding sensor samples SS(n) by transformation, such transformation comprising DCT, KLT and/or LDA transformation (and potentially the selection of principal components). In use, the sensor samples SS(n) may then be converted into such candidate vectors CV(n) too, by the same transformation as used for the input-output pairs, and those candidate vectors CV(n) provided to the trained ML classifier 200ML for classification.

It will be appreciated that machine learning could also be used to determine the centroids for desired button presses, with this information then used by the classifier 200 in its various variations discussed above. The critical centroid threshold (defining a target region relative to such a centroid) may then be pre-set or adjusted empirically.

In the above examples, methods for classifying candidate sensor samples SS(n) based on corresponding candidate vectors CV(n) as belonging to a particular virtual button press, or as an anomaly, have been considered in connection with the classifier 200. Additionally, classification using the trained ML classifier 200ML has been considered.

Such classification may be made independently for each input sensor sample SS(n), i.e. on a sample-by-sample basis. However, it may be desirable to combine classifications of more than one candidate sensor sample SS(n) to obtain a more robust button classification.

In this regard, the determiner 300 of FIG. 4 may be configured to receive a stream of (series of) classification results CR(n), corresponding to a stream of candidate sensor samples SS(n), and output a series of or stream of (corresponding) event determinations E(n). Event determinations E(n) may each be based on a plurality of classification results CR(n), for example a plurality of consecutive classification results CR(n). The determiner may output at least one event determination based on the classification results CR(n).

Looking at FIG. 4 and ignoring for now whether the classifier 200 is provided (as shown), or whether the trained ML classifier 200 ML or another classifier is provided instead, the combination 400 may be considered to correspond to a classification system (e.g. system 180) for classifying sensor samples, the classification system comprising a classifier and a determiner. The determiner in one arrangement may be a state machine.

In this respect, the classifier (e.g. classifier 200 or 200ML) may be configured, for each of a series of candidate sensor samples SS(n), to perform a classification operation based on the N sample values concerned and generate a classification result CR(n) which labels the candidate sensor sample as indicative of a defined target event (of a plurality of possible defined target events, at least one of which may correspond to an anomalous user input), thereby generating a series of classification results CR(n) corresponding to the series of candidate sensor samples SS(n), respectively. The determiner (taking the example of a state machine, such as a finite state machine) 300 may be configured to transition between defined states based on the series of classification results.

At least one state may indicate that the defined target event occurred. The determiner 300 may be configured to output a signal indicating a current state of the state machine and/or indicating when the current state indicates that the defined target event occurred.

As an example, the determiner 300 may be configured to indicate with the event determinations E(n) that a particular virtual button is pressed only if the button classifications CR(n) remain stable (i.e. classify the sensor samples as corresponding to the same virtual button press) for R consecutive sample times. R may typically be a small number that can optionally be adjusted to trade off robustness for latency in the identification of a button press. When a magnitude threshold is also used as described above, this may correspond to the force also needing to be above the magnitude threshold, for the R consecutive sample times. This may increase system robustness, akin to “debouncing”.

The determiner may be configured to take into account additional information, i.e. beyond the classifications CR(n). For example, in order to implement a degree of hysteresis, the classifications CR(n) may be provided to the determiner along with a confidence metric, and this may control how readily one state (e.g. a virtual button 1, VB1, press) is changed to another state (e.g. a virtual button 2, VB2, press). The confidence metric for example may be distance information, indicating the distance of the candidate location for the sensor sample SS(n) concerned from the centroid of one or more of the target regions. Such a confidence metric may serve as quantitative (rather than just discreet) information. For instance, in the above example, in order to change from the VB1 press state to the VB2 press state, and to implement hysteresis, it may be that greater confidence (less distance from centroid) in the VB2 press state is required to switch states than the confidence in the VB1 press state to stay in the current VB1 press state. Thus, if in the VB1 press state, it may be that candidate locations may need to be closer to the centroid for the VB2 press state in order to switch to the VB2 press state than if the present state were not a button press state (e.g. a “no user input” state).

The skilled person will recognise that the force sensors referred to herein are an example type of sensor, and that the techniques described herein may be applied to sensor systems having sensors in general. As such, references to a force sensor may be replaced by references to a sensor or to an electrical or electronic sensor or to an input transducer.

The skilled person will recognise that some aspects of the above described apparatus (circuitry) and methods may be embodied as processor control code, for example on a non-volatile carrier medium such as a disk, CD- or DVD-ROM, programmed memory such as read only memory (Firmware), or on a data carrier such as an optical or electrical signal carrier. For example, the classifier 200, 200ML or 400 may be implemented as a processor operating based on processor control code. As another example, the determiner 300 may be implemented as a processor operating based on processor control code. As another example, the controller 110 may be implemented as a processor operating based on processor control code.

For some applications, such aspects will be implemented on a DSP (Digital Signal Processor), ASIC (Application Specific Integrated Circuit) or FPGA (Field Programmable Gate Array). Thus the code may comprise conventional program code or microcode or, for example, code for setting up or controlling an ASIC or FPGA. The code may also comprise code for dynamically configuring re-configurable apparatus such as re-programmable logic gate arrays. Similarly, the code may comprise code for a hardware description language such as Verilog TM or VHDL. As the skilled person will appreciate, the code may be distributed between a plurality of coupled components in communication with one another. Where appropriate, such aspects may also be implemented using code running on a field-(re)programmable analogue array or similar device in order to configure analogue hardware.

Some embodiments of the present invention may be arranged as part of an audio processing circuit, for instance an audio circuit (such as a codec or the like) which may be provided in a host device as discussed above. A circuit or circuitry according to an embodiment of the present invention may be implemented (at least in part) as an integrated circuit (IC), for example on an IC chip. One or more input or output transducers (such as a force sensor 130) may be connected to the integrated circuit in use.

It should be noted that the above-mentioned embodiments illustrate rather than limit the invention, and that those skilled in the art will be able to design many alternative embodiments without departing from the scope of the appended claims. The word “comprising” does not exclude the presence of elements or steps other than those listed in the claim, “a” or “an” does not exclude a plurality, and a single feature or other unit may fulfil the functions of several units recited in the claims. Any reference numerals or labels in the claims shall not be construed so as to limit their scope.

As used herein, when two or more elements are referred to as “coupled” to one another, such term indicates that such two or more elements are in electronic communication or mechanical communication, as applicable, whether connected indirectly or directly, with or without intervening elements.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative. Accordingly, modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set.

Although exemplary embodiments are illustrated in the figures and described below, the principles of the present disclosure may be implemented using any number of techniques, whether currently known or not. The present disclosure should in no way be limited to the exemplary implementations and techniques illustrated in the drawings and described above.

Unless otherwise specifically noted, articles depicted in the drawings are not necessarily drawn to scale.

All examples and conditional language recited herein are intended for pedagogical objects to aid the reader in understanding the disclosure and the concepts contributed by the inventor to furthering the art, and are construed as being without limitation to such specifically recited examples and conditions. Although embodiments of the present disclosure have been described in detail, it should be understood that various changes, substitutions, and alterations could be made hereto without departing from the spirit and scope of the disclosure.

Although specific advantages have been enumerated above, various embodiments may include some, none, or all of the enumerated advantages. Additionally, other technical advantages may become readily apparent to one of ordinary skill in the art after review of the foregoing figures and description.

To aid the Patent Office (USPTO) and any readers of any patent issued on this application in interpreting the claims appended hereto, applicants wish to note that they do not intend any of the appended claims or claim elements to invoke 35 U.S.C. § 112 (f) unless the words “means for” or “step for” are explicitly used in the particular claim.

1. A classifier for classifying sensor samples in a sensor system, the sensor system comprising N force sensors each configured to output a sensor signal, where N>1, each sensor sample comprising N sample values from the N sensor signals, respectively, defining a sample vector in N-dimensional vector space, the classifier having access to a target definition corresponding to a target event, the target definition defining a bounded target region of X-dimensional vector space, where X<N, the classifier configured, for a candidate sensor sample, to perform a classification operation comprising:
determining a candidate location in the X-dimensional vector space defined by a candidate vector corresponding to the candidate sensor sample, the candidate vector being the sample vector for the candidate sensor sample or a vector derived therefrom; and
generating a classification result for the candidate sensor sample based on the candidate location, the classification result labelling the candidate sensor sample as indicative of the target event if the candidate location is within the target region.

2. The classifier as claimed in claim 1, configured in a tightening operation to adjust the target definition to reduce a size of the target region, and/or in a loosening operation to adjust the target definition to increase the size of the target region optionally configured to carry out the tightening operation and/or the loosening operation in response to a sensitivity control signal.

3. (canceled)

4. The classifier as claimed in claim 1, wherein the target definition defines the bounded target region relative to a target location in the X-dimensional vector space, optionally being an optimum or preferred location corresponding to the target event concerned.

5. The classifier as claimed in claim 4, wherein:
the target definition defines the bounded target region as locations in the X-dimensional vector space within a target distance of the target location; and
the classifier is configured in the classification operation to label the candidate sensor sample with its classification result as indicative of the target event if the candidate location is within the target distance of the target location.

6. The classifier as claimed in claim 1, configured in the classification operation to apply a mathematical transformation to the sample vector to generate the candidate vector.

7. The classifier as claimed in claim 6, wherein the transformation comprises at least one of:
a discrete cosine transformation, DCT;
a Karhunen-Loeve transformation, KLT; and/or
Linear Discriminative Analysis, LDA.

8. (canceled)

9. The classifier as claimed in claim 6, wherein the transformation comprises:
a normalisation operation, optionally being a weighted normalisation operation; and/or
a dimension-reduction operation configured to generate the candidate vector with reduced dimensions compared to the sample vector, where X<N.

10. The classifier as claimed in claim 9, wherein the target region comprises a target sub-region which is on a hypersurface defined in the X-dimensional vector space, and the classifier is configured to:
for each sensor sample, apply the normalisation operation in generating the candidate vector to normalise the magnitude of the candidate vector so that it defines a location on the hypersurface; and
in the classification operation, label the candidate sensor sample with its classification result as indicative of the target event if:
the candidate location is within the target sub-region; or
the candidate location is within the target sub-region and a magnitude of the sample vector or candidate vector meets a defined target criterion.

11. The classifier as claimed in claim 10, wherein:
the hypersurface defines a hypersphere or a hyperellipsoid; and/or
the hypersurface defines a unit-radius hypersphere and the normalisation operation causes the candidate vector to be a unit-length vector.

12. The classifier as claimed in claim 10, wherein the defined target criterion comprises the magnitude of the sample vector or candidate vector exceeding a target threshold value.

13. The classifier as claimed in claim 1, having access to a plurality of target definitions corresponding respectively to a plurality of target events, each target definition defining a corresponding bounded target region of the X-dimensional vector space, the classifier configured in the classification operation to:
label the candidate sensor sample with its classification result as indicative of one or more of the plurality of target events based on whether the candidate location is within the corresponding target regions.

14. The classifier as claimed in claim 13, configured in the classification operation to, if the candidate location is within the target region of at least two target events, label the candidate sensor sample with its classification result as indicative of only one of the at least two target events, optionally based on a comparison of proximities of the candidate location to respective defined reference locations within the target regions of the at least two target events;
optionally wherein the defined reference locations are centroids of the target regions concerned and/or defined optimum or preferred locations corresponding to the target events concerned.

15. The classifier as claimed in claim 14, wherein the defined reference locations are centroids of the target regions concerned and/or defined optimum or preferred locations corresponding to the target events concerned.

16. The classifier as claimed in claim 1, configured in the classification operation to label the candidate sensor sample with its classification result as indicative of an anomalous event if the candidate location is not within a defined target region.

17. The classifier as claimed in claim 1, configured to perform a series of classification operations for a series of candidate sensor samples to generate a corresponding series of classification results, respectively, and to determine that a given target event occurred based on the series of classification results.

18. The classifier as claimed in claim 17, configured to determine that the given target event occurred if:
at least a threshold number of those classification results label their candidate sensor samples as indicative of the given target event; and/or
at least the threshold number of those classification results which are consecutive in the series of classification results label their candidate sensor samples as indicative of the given target event.

19. The classifier as claimed in claim 17, comprising:
a state machine configured to transition between defined states based on the series of classification results, at least one said state indicating that a defined target event occurred, wherein the classifier is configured to determine that the defined target event occurred when the current state indicates that the defined target event occurred.

20. (canceled)

21. The classifier as claimed in claim 1, configured to generate at least one target definition based on a corresponding training dataset of training sensor samples recorded for the target event concerned.

22-24. (canceled)

25. A trained machine learning (ML) classifier for classifying sensor samples in a sensor system, the sensor system comprising N force sensors each configured to output a sensor signal, where N>1, each sensor sample comprising N sample values from the N sensor signals, respectively, the trained ML classifier trained to classify a candidate sensor sample as corresponding to one or none of a number of defined target events based on its sample values, the trained ML classifier configured to:
receive a candidate sensor sample; and
generate a classification result for the candidate sensor sample labelling the candidate sensor sample as indicative of one or none of the number of defined target events.

26. (canceled)

27. A classification system for classifying sensor samples in a sensor system, the sensor system comprising N force sensors each configured to output a sensor signal, where N≥1, each sensor sample comprising N sample values from the N sensor signals, respectively, the classification system comprising a classifier and a state machine, wherein:
the classifier is configured, for each of a series of candidate sensor samples, to perform a classification operation based on the N sample values concerned and generate a classification result which labels the candidate sensor sample as indicative of a defined target event, thereby generating a series of classification results corresponding to the series of candidate sensor samples, respectively; and
the state machine is configured to transition between defined states based on the series of classification results.

28-35. (canceled)
